(19) United States
(12) Patent Application Publication
(10) Pub. No.: US 2011/0198297 A1
(43) Pub. Date: Aug. 18, 2011

(54) WATER FILTRATION SYSTEM

(76) Inventor: Michael Ubri, Toledo, OH (US)

(21) Appl. No.: 13/121,525

(22) PCT Filed: Sep. 29, 2009
(86) PCT No.: PCT/US2009/058740

§ 371 Date: Mar. 29, 2011

Related U.S. Application Data
(60) Provisional application No. 61/194,623, filed on Sep. 29, 2008.

(51) Int. Cl. C02F 1/52

(52) U.S. Cl. 210/722; 210/198.1

(57) ABSTRACT

A water filtration system (2) and method includes a conduit network (4) configured to transport a treatment stream of water. An air compressor (10) is in fluid communication with the conduit network (4) configured to inject compressed air into the treatment stream (2) oxidizing a first portion of the dissolved iron. At least one closed pressure contact vessel (6) is in fluid communication with the conduit network (4). At least one filter tank (14) is in fluid communication with the at least one closed pressure contact vessel (6) having a first filtering media (16) adapted to adjust the pH of the treatment stream for oxidation of a second portion of the dissolved iron. At least one polishing filter tank (18) is in fluid communication with the at least one filter tank (14) having a second filtering media (22) adapted to catalyze the oxidation of any residual dissolved iron.

### CROSS-REFERENCE TO RELATED APPLICATIONS

This application claims the benefit of U.S. Provisional Application No. No. 61/194,623, filed on Sep. 29, 2008. The entire disclosure of the above application is hereby incorporated herein by reference.

### FIELD OF THE INVENTION

The present disclosure relates to a water filtration system and more particularly to a system and method for removing iron from a water supply.

### BACKGROUND OF THE INVENTION

Nursery and greenhouse growers have long recognized that monitoring and controlling water quality is important to plant growth and management. Poor water quality may lead to nutrient deficiencies that increase disease susceptibility. Poor water quality may also result in aesthetically displeasing plants. Typical water quality problems faced by nursery and greenhouse growers are salt, pH and alkaline levels. Iron and manganese deficiencies also tend to be common. If appropriately monitored and detected, many water quality issues can be corrected through use of various treatments, such as fertilizers, acid treatments, and the like.

A high quantity of iron in the water, sometimes called soluble ferrous iron, is a particularly problematic water quality issue. Iron in irrigation water will accumulate on plants over time. High iron in irrigation water is particularly undesirable because the iron causes a brown casting that negatively impacts the overall aesthetics of the plants. Although it is known to remove iron from water through ion exchange with a common salt, such as sodium chloride, the sodium may also undesirably build up in the soil and on the plants after repeated irrigation, Additionally, the source of the salt must be regularly replenished and therefore, ion exchange systems are costly to operate.

There is a continuing need for a system and method that militates against undesirably high iron content in water. Desirably, the system and method cost effectively removes iron and renders water suitable for use by nursery and greenhouse owners.

### SUMMARY OF THE INVENTION

In concordance with the instant disclosure, a system and method that cost effectively militates against undesirably high iron contents in water, and that renders water suitable for use by nursery and greenhouse owners, is surprisingly discovered.

In one embodiment, a system for removing iron from water includes a conduit network configured to transport a treatment stream of water from a water source. The treatment stream has a quantity of dissolved iron. An air compressor is in fluid communication with the conduit network and configured to inject compressed air into the treatment stream. At least one closed pressure contact vessel is in fluid communication with the conduit network and configured to hold the treatment stream and the compressed air for oxidation of a first portion of the dissolved iron. At least one filter tank is in fluid communication with the at least one closed pressure contact vessel. The filter tank has a first filtering media adapted to adjust the pH of the treatment stream for oxidation of a second portion of the dissolved iron. The system further includes at least one polishing filter tank in fluid communication with the at least one filter tank. The polishing filter tank has a second filtering media adapted to catalyze the oxidation of any residual dissolved iron in the water.

In another embodiment, a method for removing dissolved iron from water, includes the steps of: introducing a quantity of oxygen into the water, wherein a first portion of the dissolved iron in the water is oxidized and precipitates; filtering the water through a first filtering media adapted to adjust the pH of the water, wherein a second portion of the dissolved iron in the water is oxidized and precipitates; and filtering the water through a second filtering media adapted to catalyze the oxidation of any residual dissolved iron, wherein clear water is generated for irrigation by a nursery or greenhouse.

In a further embodiment, the method for removing dissolved iron from water includes the step of providing and operating the system for removing iron from water.

### DRAWINGS

The above, as well as other advantages of the present disclosure, will become readily apparent to those skilled in the art from the following detailed description, particularly when considered in the light of the drawing described hereafter.

FIG. 1 is a schematic representation of the water filtration system according to one embodiment of the present disclosure.

### DETAILED DESCRIPTION OF THE INVENTION

The following description is merely exemplary in nature and is not intended to limit the present disclosure, application, or uses. It should also be understood that throughout the drawings, corresponding reference numerals indicate like or corresponding parts and features. In respect of the methods disclosed, the steps presented are exemplary in nature, and thus, are not necessary or critical.

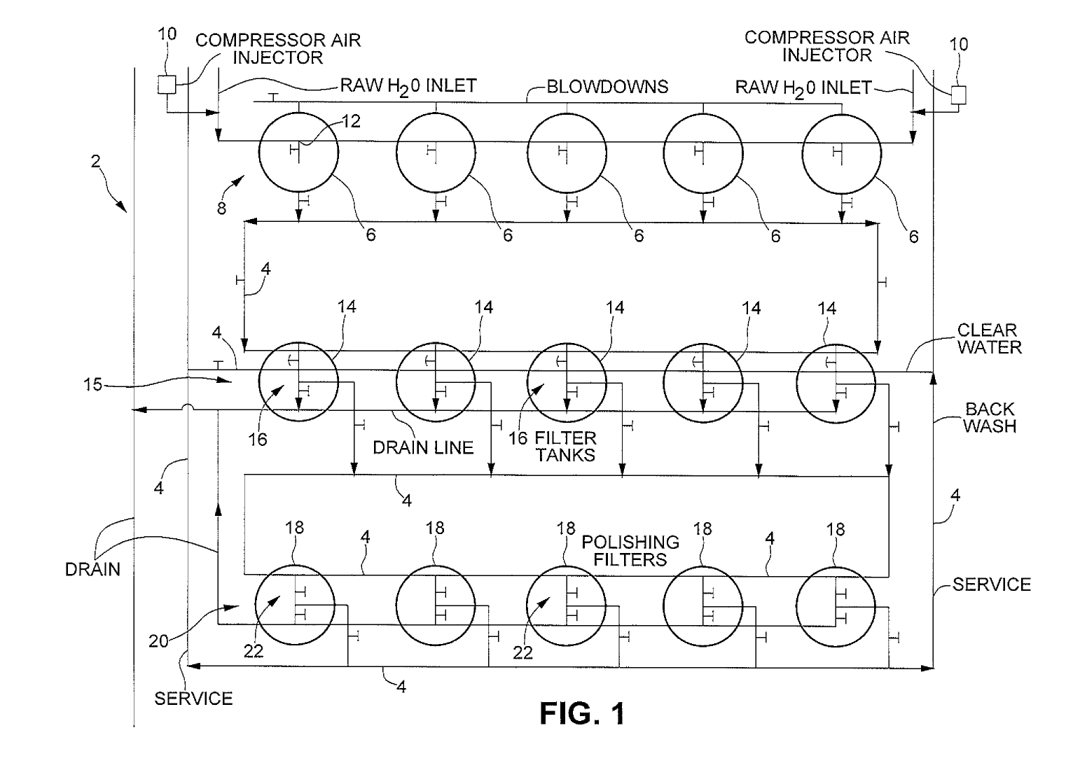

As shown in FIG. 1, the present disclosure includes a system 2 for removing iron from a water source (not shown). The water source may be any source of water having a quantity of soluble ferrous iron dissolved therein. As used herein, the term “dissolved iron” is defined to include soluble ferrous iron and other soluble iron compounds present in the water in a non-filterable state. For example, the water source may be a water well, or a holding tank or pool that is fed from a water well. Other sources of water may also be employed.

The system 2 includes a conduit network 4 for delivery of a treatment stream of water from the water source to and throughout the system 2. The conduit network 4 includes conduits for communication between various tanks and holding vessels of the system 2. The conduit network 4 may also include valves, service lines, drain pipes, blow down lines, and back wash lines, as described further herein, in fluid communication with the tanks and holding vessels of the system 2.

The conduit network 4 is in fluid communication with the water source and at least one closed pressure contact vessel 6. For example, the closed pressure contact vessel 6 may be a 120-gallon tank. Vessels configured to hold other desirable volumes of water may also be employed. The at least one closed pressure contact vessel 6 may be present as a first bank 8 of tanks in fluid communication with one another via the conduit network 4. The first bank 8 may include between about 5 and about 10 closed pressure contact vessels 6 in fluid communication with one another via the conduit network 4. It should be understood, however, that the first bank 8 may include any number of the at least one closed pressure contact vessels 6, as desired.

The system 2 further includes at least one air compressor 10. The air compressor 10 is in fluid communication with the conduit network 4. The air compressor 10 is further configured to inject compressed air into the treatment stream transported by the conduit network 4, and increase the dissolved oxygen content of the water source. The air saturates the water with a multitude of very fine bubbles. It should be understood that in a typical supply of well water having high iron content, the increase in the dissolved oxygen content of the treatment stream results in an oxidation of dissolved iron. The oxidized iron subsequently precipitates in the form of ferric oxide or ferric hydroxide and can be filtered from the treatment stream.

In one embodiment, the system 2 may include a pair of air compressors 10. The air compressors 10 may be configured to operate in an alternating fashion. For example, the air compressors 10 may be in electrical communication with a relay that functions to select back and forth between the air compressors 10 during sequential start-ups of the system 2. It should be appreciated that operation of the air compressor 10 in the alternating fashion may lengthen the life expectancy of each of the air compressors 10 in the system 2, as well and improve a safety of the same.

The closed pressure contact vessel 6 is configured to hold both a quantity of the air introduced to the system 2 by the air compressor 10 and a quantity of the water from the treatment stream. The closed pressure contact vessel 6 is also configured to facilitate the reaction of the dissolved iron in the water from the water source and oxygen from the air compressor 10. As a nonlimiting example, oxidation and precipitation of approximately seventy percent (70%) to approximately eighty percent (80%) of the dissolved iron may occur in the closed pressure contact vessel 6.

Due to the introduction of air to the treatment stream in the conduit network 4, the water in the closed pressure contact vessel 6 is present under a volume of pressurized air. In a particular embodiment, the closed pressure contact vessel 6 has an air release valve 12 that is configured to open and relieve the pressure of the closed pressure contact vessel 6, as desired. The air release valve 12 may be configured to open when the quantity of water in the closed pressure contact vessel 6 or the pressure of the air over the water reaches a predetermined level, for example. Where the level of the water in the closed pressure contact vessel 6 decreases to the predetermined level, the air release valve 12 may open and militate against an undesirable amount of air being present in the closed pressure contact vessel 6. The air release valve 12 may be actuated by a float, for example, that indicates when the predetermined level of the water is reached. As a nonlimiting example, the predetermined level may be a volume of water that fills about eighty percent (80%) of the closed pressure contact vessel 6. Other suitable predetermined levels may be selected, as desired.

The treatment stream entering the closed pressure contact vessel 6 may enter through a nozzle (not shown) configured to spray the water in a diffuse spray pattern. As a nonlimiting example, the nozzle has a restriction that causes the water to spray though the volume of pressurized air above the water in the closed pressure contact vessel 6. One of ordinary skill in the art should understand that diffusing the water from the treatment stream through the air may further facilitate an increase in the dissolved oxygen content of the water.

The closed pressure contact vessel 6 may further be in fluid communication with a blow down conduit of the conduit network 4 that facilitates a draining and servicing of the system 2, as desired.

The system 2 also includes at least one filter tank 14 in fluid communication with the at least one closed pressure contact vessel 6 via the conduit network 4. The at least one filter tank 14 may be present as a second bank 15 of tanks in fluid communication with one another via the conduit network 4. The second bank 15 may include between about five and about ten filter tanks 14 in fluid communication with one another via the conduit network 4. It should be understood, however, that the first bank 8 may include any number of the filter tanks 14, as desired. The at least one filter tank 14 is further in fluid communication with the at least one closed pressure contact vessel 6.

The filter tank 14 holds a first filtering media 16. The first filtering media 16 is adapted to adjust the pH of the water when the treatment stream is directed from the closed pressure contact vessel 6 to the filter tank 14. The first filtering media 16 may include a blend of a calcium carbonate media and a magnesium oxide media, for example. In a particular embodiment, the first filtering media 16 is a blend of Calcite and Corosex® filter media, both manufactured by Clack Corporation, located in Windsor, Wis. In a most particular embodiment the first filtering media 16 is a blend of about 90% Calcite and about 10% Corosex® filter media. It should be appreciated that the particular ratio of Calcite to Corosex® filter media may be selected as desired, for example, depending on the acidity of the water supply. Other suitable material for the first filtering media 16 may be used as desired.

The first filtering media 16 may be evenly distributed throughout the filter tank 14 and supported on a bed of gravel, for example. From about ninety-five percent (95%) to about ninety-eight (98%) of the dissolved iron may be oxidized and precipitated in the at least one filter tank 14 upon contact with the first filtering media 16.

The at least one filter tank 14 may be in fluid communication with a back wash conduit of the conduit network 4 that is adapted to back wash water through the at least one filter tank 14 on a periodic basis. For example, the back wash conduit may be employed to back wash water through the at least one filter tank 14 following an irrigation period. In certain embodiments, the back wash stream may be untreated ground water from the water supply. In a particular embodiment, the back wash stream includes water that has been filtered by the system 2. A skilled artisan should understand that the employment of clear water that has been filtered by the system 2 in back washing the at least one filter tank 14 may result in a more thorough cleaning of the at least one filter tank 14.

The system 2 further includes at least one polishing filter tank 18. The at least one polishing filter tank 18 may be present as a third bank 20 of tanks in fluid communication with one another via the conduit network 4. The third bank 20 may include between about 5 and about 10 polishing filter tanks 18 in fluid communication with one another via the conduit network 4. It should be understood, however, that the third bank 20 may include any number of the polishing filter tanks 18, as desired. The at least one polishing filter tank 18 is in fluid communication with the at least one filter tank 14.

The polishing filter tank 18 holds a second filtering media 22 adapted to catalyze the reaction of the dissolved oxygen with the dissolved iron in the treatment stream from the at least one filter tank 14. The second filtering media 22 may be a granular filter media, such as an aluminum silicate or natural pumice material, having a manganese oxide coating, for example. In a particular embodiment, the second filter media 22 is Birm® filter media manufactured by Clack Corporation, located in Windsor, Wisconsin. Birm® filter media acts as an insoluble catalyst to enhance the reaction between dissolved oxygen and iron compounds in the water. In ground waters, the dissolved iron is usually in the ferrous bicarbonate state due to an excess of free carbon dioxide. Birm® acts as a catalyst between the oxygen and the soluble iron compounds, and produces ferric hydroxide which precipitates and may be filtered. Other suitable materials may be used for the second filtering media 22 as desired.

The second filtering media 22 may be evenly distributed throughout the polishing filter tank 18 and supported on a bed of gravel, for example. One of ordinary skill in the art should understand that the second filtering media 22 is employed to remove at least a portion of any residual dissolved iron present in the treatment stream following reaction in the at least one filter tank 14. The resulting filtered or clear water having a minimized dissolved iron content may subsequently be employed for irrigation purposes.

The present disclosure further includes a method for removing iron from water. The method includes the steps of: introducing a quantity of oxygen into the water, wherein a first portion of the dissolved iron in the water is oxidized and precipitates; filtering the water through a first filtering media 16 adapted to adjust the pH of the water, wherein a second portion of the dissolved iron in the water is oxidized and precipitates; and filtering the water through a second filtering media 22 adapted to catalyze the oxidation of any residual dissolved iron. Clear water having a minimized iron content, and preferably substantially no dissolved iron, is thereby generated and may be used for irrigation purposes.

The method may further include the step of rinsing the first filtering media 16 on a periodic basis. For example, the first filtering media 16 may be back washed with the clear water generated by the system 2. The precipitated ferric oxide and ferric hydroxide may then be disposed of down a drain or in a waste system, for example, and the first filtering media 16 reused.

A skilled artisan should understand that the system 2 and method of the present disclosure removes dissolved iron from water via oxidation, precipitation, and filtration in a cost effective manner. The use of salts and ion exchange equipment typically employed for iron removal is thereby militated against.

While certain representative embodiments and details have been shown for purposes of illustrating the invention, it will be apparent to those skilled in the art that various changes may be made without departing from the scope of the disclosure, which is further described in the following appended claims.

What is claimed is:

1. A system for removing dissolved iron from water, comprising:
a conduit network configured to transport a treatment stream of water from a water source, the treatment stream having a quantity of dissolved iron;
an air compressor in fluid communication with the conduit network and configured to inject compressed air into the treatment stream;
at least one closed pressure contact vessel in fluid communication with the conduit network and configured to hold the treatment stream and the compressed air for oxidation of a first portion of the dissolved iron;
at least one filter tank in fluid communication with the at least one closed pressure contact vessel, the filter tank having a first filtering media adapted to adjust the pH of the treatment stream for oxidation of a second portion of the dissolved iron; and
at least one polishing filter tank in fluid communication with the at least one filter tank, the polishing filter tank having a second filtering media adapted to catalyze the oxidation of any residual dissolved iron and thereby generate a stream of clear water.

2. The system of claim 1, wherein the conduit network includes a blow down conduit in fluid communication with the at least one closed pressure contact vessel for facilitating a draining and servicing of the system.

3. The system of claim 1, wherein the at least one closed pressure contact vessel has an air release valve militating against an undesirable amount of air being present in the closed pressure contact vessel.

4. The system of claim 1, wherein the conduit network includes a back wash conduit in fluid communication with the at least one filter tank adapted to back wash water through the at least one filter tank.

5. The system of claim 4, wherein the back wash conduit is in fluid communication with the at least one polishing filter tank and is adapted to back wash the clear water through the at least one filter tank.

6. The system of claim 1, wherein the first filtering media of the at least one filter tank is evenly distributed throughout the filter tank and supported on a bed of gravel.

7. The system of claim 1, wherein the filter filtering media is a blend of calcium carbonate media and magnesium oxide media.

8. The system of claim 1, wherein the second filtering media of the at least one polishing filter tank is evenly distributed throughout the filter tank and supported on a bed of gravel.

9. The system of claim 1, wherein the second filtering media is a granular filter media formed from at least one of aluminum silicate and natural pumice material with a manganese oxide coating.

10. The system of claim 1, wherein the conduit network includes at least one drain line in fluid communication with the at least one filter tank and the at least one polishing filter tank.

11. The system of claim 1, wherein the conduit network includes at least one service line in fluid communication with the at least one polishing filter tank and adapted to transport the stream of the clear water from the system.

12. A method for removing dissolved iron from water, comprising the steps of:
providing a treatment stream of water having a quantity of dissolved iron;
introducing a quantity of oxygen into the water, wherein a first portion of the dissolved iron in the water is oxidized and precipitates;
filtering the water through a first filtering media adapted to adjust the pH of the water, wherein a second portion of the dissolved iron in the water is oxidized and precipitates; and
filtering the water through a second filtering media adapted to catalyze the oxidation of any residual dissolved iron, wherein a stream of clear water is generated.

13. The method of claim 12, further including the step of providing a system for removing iron from water, the system including a conduit network configured to transport the treatment stream of water from a water source, the treatment stream having a quantity of dissolved iron, an air compressor in fluid communication with the conduit network and configured to inject compressed air into the treatment stream, at least one closed pressure contact vessel in fluid communication with the conduit network and configured to hold the treatment stream and the compressed air for oxidation of the first portion of the dissolved iron, at least one filter tank in fluid communication with the at least one closed pressure contact vessel, the filter tank having the first filtering media adapted to adjust the pH of the treatment stream for oxidation of the second portion of the dissolved iron, and at least one polishing filter tank in fluid communication with the at least one filter tank, the polishing filter tank having the second filtering media adapted to catalyze the oxidation of any residual dissolved iron and thereby generate the stream of clear water.

14. The method of claim 12, further including the step of rinsing the first filtering media on a periodic basis.

15. The method of claim 14, wherein the step of rinsing the first filtering media includes back washing the first filtering media with the stream of clear water generated.

16. The method of claim 12, where the step of introducing the quantity of oxygen into the water is performed by injecting compressed air into the water.

17. The method of claim 12, wherein the step of introducing the quantity of oxygen into the water is performed by spraying the water in a diffuse spray pattern through a volume of pressurized air to increase a dissolved oxygen content of the water.

18. The method of claim 12, wherein the step of introducing the quantity of oxygen into the water is performed until from about 70% to about 80% of the dissolved iron is oxidized, the step of filtering the water through the first filtering media is performed until from about 95% to about 98% of the dissolved iron is oxidized, and the step of filtering the water through the second filtering media is performed until substantially no dissolved iron is present in the water.

19. The method of claim 12, further including the step of irrigating at least one of a nursery and a greenhouse with the stream of clear water.

20. A method for removing dissolved iron from water, comprising the steps of:
providing a treatment stream of water having a quantity of dissolved iron;
providing a system for removing iron from water, the system including a conduit network configured to transport the treatment stream of water from a water source, an air compressor in fluid communication with the conduit network and configured to inject compressed air into the treatment stream, at least one closed pressure contact vessel in fluid communication with the conduit network and configured to hold the treatment stream and the compressed air for oxidation of the first portion of the dissolved iron, at least one filter tank in fluid communication with the at least one closed pressure contact vessel, the filter tank having a first filtering media adapted to adjust the pH of the treatment stream for oxidation of the second portion of the dissolved iron, the first filtering media being a blend of calcium carbonate media and magnesium oxide media, and at least one polishing filter tank in fluid communication with the at least one filter tank, the polishing filter tank having a second filtering media adapted to catalyze the oxidation of any residual dissolved iron, the second filtering media being a granular filter media formed from at least one of aluminum silicate and natural pumice material with a manganese oxide coating;
introducing a quantity of oxygen into the water by spraying the water in a diffuse spray pattern through a volume of pressurized air in the closed pressure contact vessel, and injecting compressed air into the water in the closed pressure contact vessel, wherein a first portion of the dissolved iron in the water is oxidized and precipitates;
filtering the water through the first filtering media adapted to adjust the pH of the water, wherein a second portion of the dissolved iron in the water is oxidized and precipitates; and
filtering the water through the second filtering media adapted to catalyze the oxidation of any residual dissolved iron, wherein a stream of clear water is generated.
